(19) United States
(12) Patent Application Publication
(10) Pub. No.: US 2019/0252101 A1
(43) Pub. Date: Aug. 15, 2019

(54) METHOD AND APPARATUS FOR ELECTROMAGNETIC WOUND COIL

(71) Applicant: G.W. Lisk Company, Inc., Clifton Springs, NY (US)

(72) Inventor: Zaccarie Peone, Seneca Falls, NY (US)

(21) Appl. No.: 15/896,750

(22) Filed: Feb. 14, 2018

(51) Int. Cl. H01F 1/18; H01F 5/02; H01F 41/063

(52) U.S. Cl. CPC H01F 1/18; H01F 41/063; H01F 5/02

(57) ABSTRACT

Embodiments of the present disclosure provide a method of manufacture and an electromagnetic wound coil assembly. An exemplary method of manufacture includes providing a coiled conductor. The method further includes applying one of a poly-ethyl-ether-ketone coating and a polyimide coating to encompass at least a portion of an outside surface of the coiled conductor, wherein the poly-ethyl-ether-ketone coating substantially prevents degradation of the coiled conductor up to at least 525 degrees Fahrenheit.

### BACKGROUND OF THE INVENTION

### Field of the Invention

Exemplary embodiments of the present disclosure relate to a method and apparatus for electromagnetic wound coil. Exemplary embodiments of the present disclosure relate more particularly to a method and apparatus for high temperature electromagnetic wound coil.

### Description of Related Art

Most existing induction coils have an upper temperature limit that prevents their ability to be reliably used in high temperature environments. Additional, those induction coils that are made for high temperature environments have a manufacturing cost that makes them economically unfeasible or prohibitive. Accordingly, there is a need for an induction coil that is operable to function in high temperatures.

### BRIEF SUMMARY OF THE INVENTION

In view of the foregoing, it is an object of the present disclosure to provide a method and apparatus for electromagnetic wound coil.

A first exemplary embodiment of the present disclosure provides a method of manufacturing an electromagnetic wound coil assembly. The method includes providing a coiled conductor. The method further includes applying one of a polyether-ether-ketone and a polyimide insulation coating to encompass at least a portion of an outside surface of the coiled conductor, wherein the poly-ethyl-ether-ketone coating and the polyimide coating substantially prevents degradation of the coiled conductor up to at least 525 degrees Fahrenheit.

A second exemplary embodiment of the present disclosure provides a method of manufacturing an electromagnetic wound coil assembly. The method includes providing a coiled conductor, the coiled conductor having a coefficient of thermal expansion. The method further includes disposing at least a portion of the coiled conductor in a ceramic potting compound, the ceramic potting compound operable to maintain a structural integrity up to at least 1000 degrees Fahrenheit. The method still further includes curing the ceramic potting compound.

A third exemplary embodiment of the present disclosure provides an electromagnetic wound coil assembly. The electromagnetic wound coil assembly includes a coiled conductor having a nickel-plated coating an outside surface of the coiled conductor, the nickel-plated coating at least partially covered by a polyether-ether-ketone coating, wherein the nickel-plated coating is operable to reduce a rate of oxidation of the coiled conductor, and wherein the polyether-ether-ketone coating substantially prevents degradation of the nickel-plated coiled conductor up to at least 450 degrees Fahrenheit.

A fourth exemplary embodiment of the present disclosure provides an electromagnetic wound coil assembly. The electromagnetic wound coil assembly includes a coiled conductor at least partially disposed in a cured ceramic potting compound, the ceramic potting compound operable to maintain a structural integrity up to at least 1000 degrees Fahrenheit.

The following will describe embodiments of the present disclosure, but it should be appreciated that the present disclosure is not limited to the described embodiments and various modifications of the invention are possible without departing from the basic principles. The scope of the present disclosure is therefore to be determined solely by the appended claims.

### BRIEF DESCRIPTION OF THE SEVERAL VIEWS OF THE DRAWING(S)

FIG. 1 is a cross-sectional view of an exemplary device suitable for performing exemplary embodiments of the present disclosure.

FIG. 2 is an interior cross-sectional view of an exemplary device suitable for performing exemplary embodiments of the present disclosure.

FIG. 3 is a side view of an exemplary coiled conductor with a retaining element suitable for performing exemplary embodiments of the present disclosure.

FIG. 4 is a top view of an exemplary device suitable for performing exemplary embodiments of the present disclosure.

FIG. 5 is a logic flow diagram in accordance with a method and apparatus for performing exemplary embodiments of the present disclosure.

FIG. 6 is an alternative logic flow diagram in accordance with a method and apparatus for performing exemplary embodiments of the present disclosure.

FIG. 7 is a graphs illustrating ratiometric error suitable for performing exemplary embodiments of the present disclosure.

FIG. 8 is a schematic diagram of devices suitable for performing exemplary embodiments of the present disclosure.

FIG. 9 is an alternative embodiments of an exemplary device suitable for performing exemplary embodiments of the present disclosure.

### DETAILED DESCRIPTION OF THE INVENTION

Embodiments of the present disclosure provide a method of forming and an apparatus operable to function at high temperature ranges. Embodiments of the present disclosure provide a method of forming and an apparatus operable to function at higher temperature ranges than traditional electromagnetic wound coil or inductive coils while minimizing the manufacturing challenges and costs associated with conventional high temperature solutions. Embodiments of the present disclosure provide an electromagnetic wound coil including an inductive coil that is operable to maintain its functionality within 0.5% amount of error at temperatures up to at least 525 degrees Fahrenheit. Embodiments of the present disclosure further provide a combination of materials operable to produce inductive coils able to operate at high temperature ranges greater than conventional materials. Embodiments of the present disclosure provides a construction operable to provide improved performance across coils operating at high temperature ranges due to the lower coefficient of thermal expansion of the materials used.

Traditional wound coils have a number of drawbacks. First, the performance is significantly reduced due to the thermal expansion of conventional potting materials, which leads to a product that can often cause the coils to fail to meet acceptable industry performance limits. Second, the amount of time a traditional induction coil is able to withstand high temperatures and maintain its required performance levels is limited. Third, existing high temperature solutions are costly and tough to manufacture. Embodiments of the present disclosure overcome these obstacles.

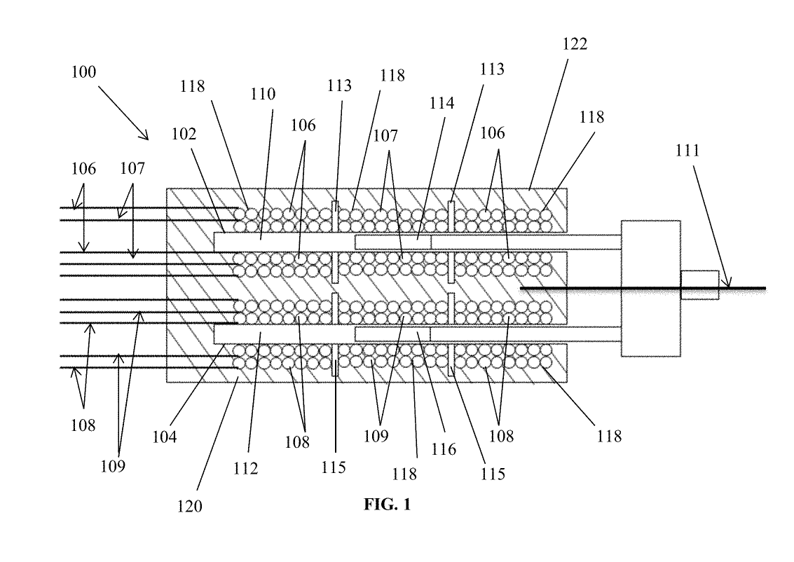

Reference is now made to FIG. 1, which depicts a cross-sectional view of an exemplary device suitable for performing exemplary embodiments of this disclosure. Shown in FIG. 1 is device 100 having a casing 102 and a casing 104. Device 100 also includes a coiled conductors 106, 107, 108, and 109. Embodiments of casing 102 and casing 104 are each cylindrically shaped and define hollow cavities 110, 112 that extend through the longitudinal axis (as shown by line 111) of casing 102 and casing 104. Embodiments of casings 102, 104 are made of non-magnetic materials. Hollow cavities 110, 112 are operable to maintain cores 114, 116, respectively. Cores 114, 116 are made of iron, other ferromagnetic materials, or conductive materials. Cores 114, 116 are operable to slideably move through the longitudinal axis 109 of hollow cavities 110, 112 in response to changes in a magnetic field or magnetic forces created by coiled conductors 106, 107, 108, and 109.

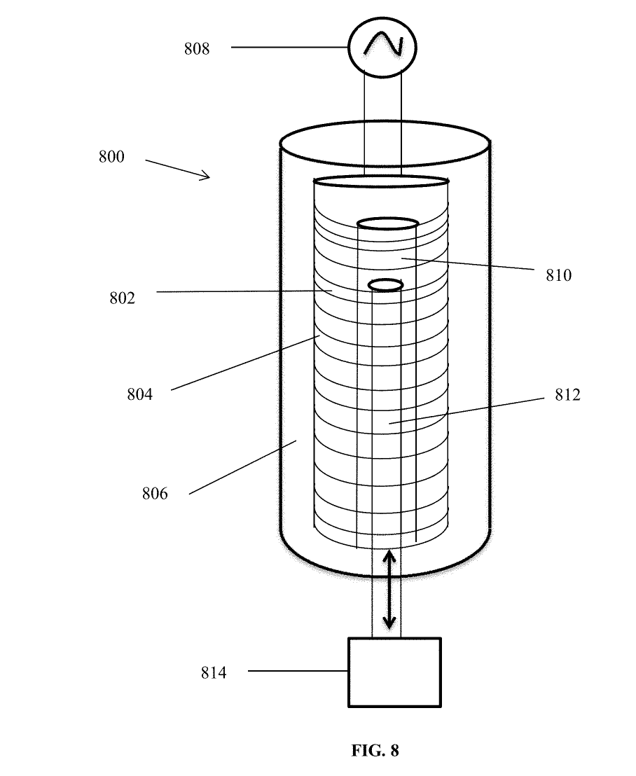

Coiled conductors 106, 107 are coiled around casing 102 such that portions of an outside surface of the longitudinal axis 111 of casing 102 is substantially surrounded by coiled conductors 106, 107. As shown in FIG. 1, coiled conductors 106, 107 are spaced from one another by spacers 113. However, it should be appreciated that embodiments include a physical space (instead of spacers 113) separating coils 106, 107. Coiled conductors 108, 109 are coiled around casing 104 such that portions of an outside surface of the longitudinal axis 111 of casing 104 are substantially surrounded by coiled conductors 108, 109. Coiled conductors 108, 109 are spaced from one another by spacers 115. However, it should be appreciated that embodiments include a physical space (instead of spacers 115) separating coils 108, 109. It should also be appreciated that while device 100 includes two casings (and two cores), embodiments include device 100 having a single casing (shown in FIG. 8) defining a hollow cavity that maintains a slideably moveable core wherein the single casing is surrounded by one or two coiled conductors. Embodiments of coiled conductors 106, 107, 108, and 109 can be made of one of nickel, copper, aluminum, and carbon nanotube. Embodiments of coiled conductors 106, 107, 108, and 109 are nickel-plated magnetic wire. In this embodiment, the nickel-plated magnet wire is a copper wire. The nickel-plated coating on coiled conductors 106, 107, 108, and 109 substantially prevent an increase in resistivity of the coiled conductor 106, 107, 108, and 109 between temperatures of 0-525 degrees Fahrenheit. In this embodiment, the nickel-plating on coiled conductors 106, 107, 108, and 109 are operable to reduce a rate of oxidation of the coiled conductors 106, 107, 108, and 109. Embodiments provide that the nickel-plating is at least 0.00025 inches thick.

Coiled conductors 106, 107, 108, and 109 have a polyether-ether-ketone coating 118 that encompasses the outside surface of coiled conductors 106, 107, 108, and 109. For the embodiment that the coiled conductors 106, 107, 108, and 109 are nickel-plated, it should be understood that the polyether-ether-ketone coating 118 completely covers or partially covers the nickel-plating. In one embodiment, the polyether-ether-ketone coating 118 encompasses at least a portion of the outside surface of coiled conductors 106, 107, 108, 109. Embodiments of polyether-ether-ketone coating 118 are operable to substantially prevent degradation of coiled conductors 106, 107, 108, and 109 at high temperatures, such as up to at least 525 degrees Fahrenheit. Degradation refers to the wearing down or erosion of the coiled conductors 106, 107, 108, and 109 due to high temperatures. Degradation also refers to the ability or decreased ability of coiled conductors 106, 107, 108, and 109 to be able to conduct a current through the entirety of coiled conductors 106, 107, 108, and 109. Embodiments provide that the polyether-ether-ketone coating 118 is operable to allow device 100 to operate at high temperature environments. Thus the polyether-ether-ketone coating can overlay the outside surfaces of the winding coiled conductors 106, 107, 108, and 109. Additionally, the polyether-ether-ketone coating overlays or can partially penetrate the winding of the coiled conductors 106, 107, 108, and 109 or encapsulate each coil of the winding/coiled conductors 106, 107, 108, and 109. In one configuration, the polyether-ether-ketone coating forms a covering over the exterior outside surface of the coiled conductors 106, 107, 108, and 109. Embodiments provide that the polyether-ether-ketone coating is applied to cover the exterior outside surface of the coiled conductors 106, 107, 108, and 109 prior to coiled conductors 106, 107, 108, and 109 being wound in a circular fashion as shown in FIGS. 1 and 8. Embodiments provide that the polyether-ether-ketone coating is at least 0.001 inches thick. It should be appreciated that while FIG. 1 has been described to specifically have a polyether-ether-ketone coating, embodiments include coiled conductors 106, 107, 108, and 109 having a polyimide coating in place of a polyether-ether-ketone coating.

Both cores 114, 116 and coiled conductors 106, 107, 108, and 109 are disposed in or substantially disposed in, or at least a portion of which is disposed in potting compound 120 such that potting compound 120 substantially surrounds or encompasses an outside surface of coiled conductors 106, 107, 108, and 109. Embodiments of potting compound 120 includes a ceramic potting compound operable to maintain a structural integrity of device 100 up to at least 1000 degrees Fahrenheit. Structural integrity refers to the ability of potting compound 120 to maintain the relative location of the cores 114, 116 to the coiled conductors 106, 107, 108, and 109 such that device 100 remains able to create a magnetic field and magnetic flux operable to urge cores 114, 116. Structural integrity also refers to the ability of potting compound 120 to maintain the relative location of each turn of coils 106, 107, 108, and 109 relative to each other turn of coils 106, 107, 108, and 109. Embodiments of potting compound 120 are operable to electrically and mechanically isolate coiled conductors 106, 107, 108, and 109 from the surrounding environment. Embodiments of potting compound 120 include Sauereisen 13-ZR, Ceramacast 900, and Ceramacast 586. Embodiments of potting compound 120 include any ceramic potting compound having a coefficient of thermal expansion the same as or similar to 2.8 (4.0) ppm/° F. (° C.), or 4.86 um/m-° C. Embodiments of potting compound 120 have a coefficient of thermal expansion that is less than the coefficient of thermal expansion of coiled conductors 106, 107, 108, and 109. Embodiments of potting compound 120 are operable to substantially prevent movement and/or expansion of coiled conductors 106, 107, 108, and 109 relative to cores 114, 116, respectively. For example, potting compound 120 prevents movement and/or expansion of coiled conductors 106, 107, 108, and 109 relative to cores 114, 116, respectively, of more than 0.0001 inches. Embodiments of potting compound 120 include ceramic compounds having a coefficient of thermal expansion similar to that found in Sauereisen 13-ZR, Ceramacast 900, and Ceramacast 586. Embodiments provide that potting compound 120 is maintained in a liquid form within container 122. After the cores 114, 116 and coiled conductors 106, 107, 108, and 109 are disposed in potting compound 120, potting compound 120 is cured until it is a solid. Potting compound 120 is operable to maintain a relative location of coiled conductors 106, 107, 108, and 109 to cores 114, 116 at high temperatures. It should be appreciated that embodiments of device 100 shown in FIG. 1 are a linear variable differential transformer (LVDT) having polyether-ether-ketone coated coiled conductors disposed in a potting compound.

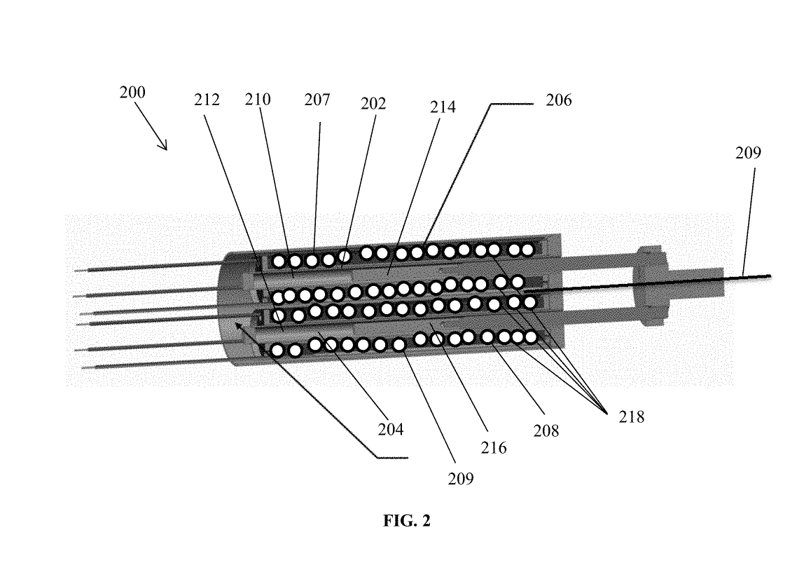

Referring to FIG. 2, shown is a cross-sectional view of device 200 that is not disposed in a potting compound. Rather, device 200 shown in FIG. 2 includes moveable cores 214, 216 maintained in cavities 210, 212 in casings 202, 204. Surrounding an outside surface of casings 202, 204 are coiled conductors 207, 208, and 209. Coiled conductors 206, 207, 208, and 209 are circularly wrapped around either casing 202 or casing 204 such that (similar to FIG. 1) each turn of coiled conductors 206, 207, 208, and 209 is spaced from one another. Additionally, coiled conductors 206, 207, 208, and 209 (again similar to FIG. 1) are each spaced from one another along the long axis 209 of casings 202, 204, respectively. Coiled conductors 206, 207, 208, and 209 are each encompassed by or surrounded by a polyether-ether-ketone coating 218. It should be appreciated that embodiments include coiled conductors 206, 207, 208, and 209 being encompassed by a polyimide coating rather than the polyether-ether-ketone coating 218. It should be appreciated that embodiments of device 200 shown in FIG. 2 are a solenoid having a polyether-ether-ketone coating, but not being disposed in a potting compound.

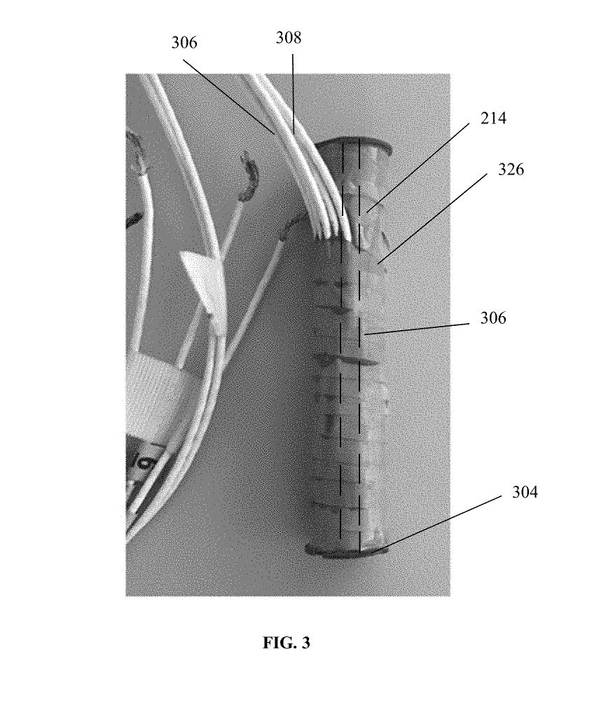

Referring to FIG. 3, shown is a side view of an exemplary coiled conductor with a retaining element suitable for performing exemplary embodiments of the present disclosure. Shown in FIG. 3 are coiled conductors 306, 308 prior to being disposed within potting compound 320. In this embodiment, coiled conductors 306, 308 are wound around bobbin 304. Bobbin 304 (shown in dotted lines 306) includes cylindrically shaped longitudinal hollow tube extending between two hollow circular disks. Coiled conductor's 306, 308 location relative to bobbin 304 are maintained by retaining element 326. In the embodiment shown in FIG. 3, retaining element 326 is tape that is wrapped or substantially wrapped around coiled conductors 306, 308. Retaining element 326 substantially prevents movement of coiled conductors 306, 308 prior to being disposed in potting compound 320. Exemplary embodiments of retaining element 326 include plastic tape, electrical tape, and tapes being made of polyimide. It should be appreciated, that embodiments include the absence of bobbin 304 such that coiled conductors 306, 308 are wound such that coiled conductors 306, 308 define a hollow center extending through the longitudinal axis of the wound coiled conductors 306, 308. In this embodiment, a location of each winding of coiled conductors 306, 308 relative to one another is substantially maintained by retaining element 326 that is wrapped around the outside surface of coiled conductors 306, 308.

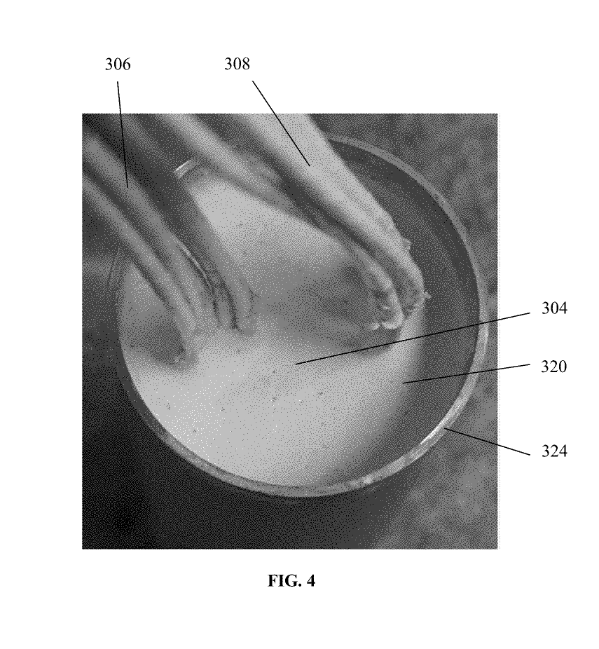

Referring to FIG. 4, shown is a top of an exemplary device suitable for performing exemplary embodiments of the present disclosure. Shown in FIG. 4 are coiled conductors 306, 308 disposed in potting compound 320 in container 324. Shown are coiled conductors 306, 308 extending from a top surface of potting compound 320. As illustrated in FIG. 4, other than the portions of coiled conductors 306, 308 extending from the top surface of potting compound 320, all of coiled conductors 306, 308 (including bobbin 304) has been disposed or submerged within potting compound 320. However, it should be appreciated that embodiments of the present disclosure contemplate portions of coiled conductors 306, 308 being disposed in potting compound 320 and portions not being disposed in potting compound 320.

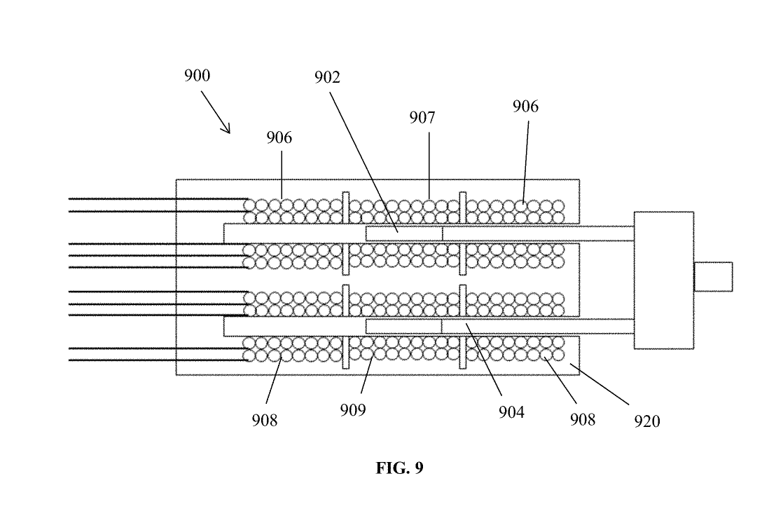

In practice, coiled conductors 106, 107, 108, and 109 are operable to be connected to a power source such that a current can pass through coiled conductors 106, 107, 108, and 109. When the current is passed through coiled conductors 106, 107, 108, and 109 a magnetic field (and magnetic flux) is produced. Embodiments provide that the created magnetic field is operable to cause cores 114, 116 to slideably move through the longitudinal axis 111 of device 100. Embodiments further provide that device 100 having coiled conductors 106, 107, 108, and 109 with the polyether-ether-ketone coating and being disposed in potting compound 120 will be able to continue to operate with reduced error at temperatures greater than 1000 degrees Fahrenheit. Reduced error refers to the ability of moveable cores 114, 116 to repeatedly maintain the same stroke length in response to the same current flow. Error also refers to the ability of moveable cores 114, 116 to repeatedly maintain the same stroke length for a corresponding electrical input (e.g., current input into coils 106, 107, 108, and 109) to electrical output (e.g., change in movement) ratio. Embodiments of device 100 having only the polyether-ether-ketone coating (shown in FIG. 2) are operable to continue to operate with reduced error at temperatures of at least 525 degrees Fahrenheit. Embodiments of device 100 having only the potting compound (shown in FIG. 9) are operable to continue to operate with reduced error at temperatures greater than 1000 degrees Fahrenheit. Exemplary embodiments of the present disclosure provide that embodiments include electromagnetic wound coil devices such as LVDTs, solenoids, motors and the like having polyether-ether-ketone coatings and/or being disposed in a potting compound to operate in high temperatures environments with reduced error. It should be appreciated that embodiments provide the use of polyimide in place of the polyether-ether-ketone coating. It should also be appreciated that embodiments include device 100 (or 200, or 900) being operable to act as an inductive coil wherein a current is passed through coils 106 and 108 such that a voltage is created from the magnetic flux in coils 107 and 109. In yet another, alternative embodiment, moveable cores 114, 116 are operable to move through cavities 110, 112 such that they cause a current to flow through coiled conductors 106, 107, and 108. It should also be appreciated that while particular embodiments shown depict coiled conductors being spaced along the long axis of devices 100 and 200, embodiments include coiled conductors overlapping one another along the long axis of devices 100 and 200 such that the coiled conductors are space from each other along an axis perpendicular to the long axis.

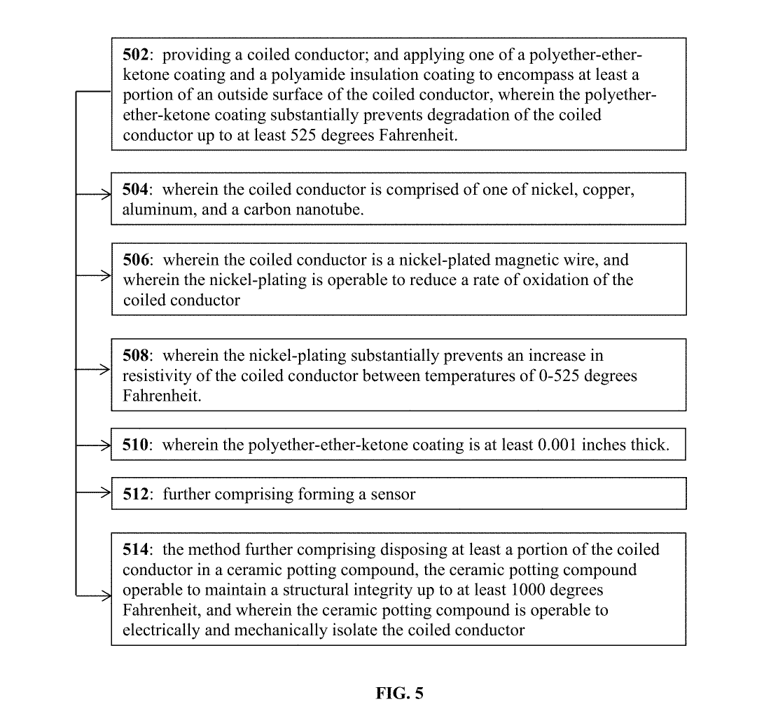

Referring to FIG. 5, shown is a logic flow diagram in accordance with a method and apparatus for performing exemplary embodiments of the present disclosure. Block 502 presents providing a coiled conductor; and applying a polyether-ether-ketone coating to encompass at least a portion of an outside surface of the coiled conductor, wherein the polyether-ether-ketone coating substantially prevents degradation of the coiled conductor up to at least 525 degrees Fahrenheit. Next, block 504 specifies wherein the coiled conductor is comprised of one of nickel, copper, aluminum, and a carbon nanotube.

Some of the non-limiting implementations detailed above are also summarized at FIG. 5 following block 504. Block 506 states wherein the coiled conductor is a nickel-plated magnetic wire, and wherein the nickel-plating is operable to reduce a rate of oxidation of the coiled conductor. Then block 508 indicates wherein the nickel-plating substantially prevents an increase in resistivity of the coiled conductor between temperatures of 0-525 degrees Fahrenheit. Block 510 relates to wherein the polyether-ether-ketone coating is at least 0.001 inches thick. Block 512 specifies further comprising forming a sensor. Finally block 514 states the method further comprising disposing at least a portion of the coiled conductor in a ceramic potting compound, the ceramic potting compound operable to maintain a structural integrity up to at least 1000 degrees Fahrenheit, and wherein the ceramic potting compound is operable to electrically and mechanically isolate the coiled conductor.

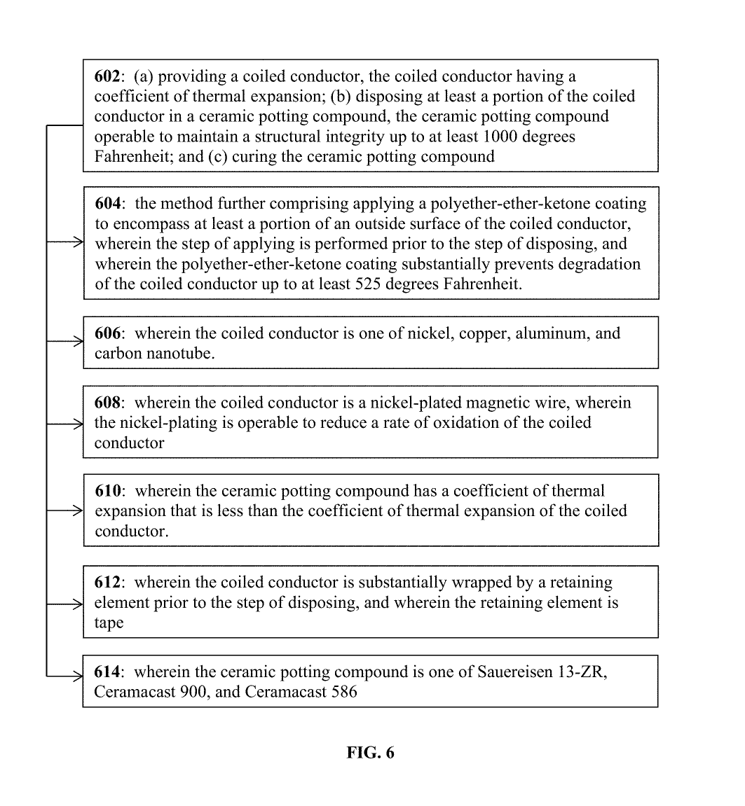

Reference is now made to FIG. 6, which presents an alternative logic flow diagram in accordance with a method and apparatus for performing exemplary embodiments of the present disclosure. Block 602 states (a) providing a coiled conductor, the coiled conductor having a coefficient of thermal expansion; (b) disposing at least a portion of the coiled conductor in a ceramic potting compound, the ceramic potting compound operable to maintain a structural integrity up to at least 1000 degrees Fahrenheit; and (c) curing the ceramic potting compound. Next block 604 relates to the method further comprising applying a polyether-ether-ketone coating to encompass at least a portion of an outside surface of the coiled conductor, wherein the step of applying is performed prior to the step of disposing, and wherein the polyether-ether-ketone coating substantially prevents degradation of the coiled copper magnetic wire up to at least 450 degrees Fahrenheit.

Following block 604, block 606 relates to wherein the coiled conductor is one of nickel, copper, aluminum, and carbon nanotube. Block 608 specifies wherein the coiled conductor is a nickel-plated magnetic wire, wherein the nickel-plating is operable to reduce a rate of oxidation of the coiled conductor. Block 610 indicates wherein the ceramic potting compound has a coefficient of thermal expansion that is less than the coefficient of thermal expansion of the coiled conductor. Block 612 states wherein the coiled conductor is substantially wrapped by a retaining element prior to the step of disposing, and wherein the retaining element is tape. Finally, block 614 specifies wherein the ceramic potting compound is one of Sauereisen 13-ZR, Ceramacast 900, and Ceramacast 586.

The logic diagrams of FIG. 5 and FIG. 6 may be considered to illustrate the operation of a method. The logic diagram of FIG. 5 and FIG. 6 may also be considered a specific manner in which components of a device that are configured to cause that device to operate, whether such a device is a coil, an electromagnetic wound coil or one or more components thereof.

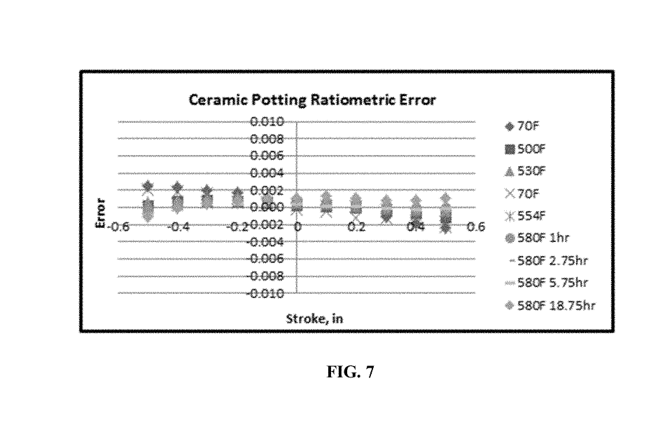

Reference is now made to FIG. 7, which depicts a graph illustrating ratiometric error for embodiments of device 100 disposed in potting compound 120. In this embodiment, device 100 is an LVDT. Shown on the right portion of the graph is a legend identifying the symbols on the graph and their corresponding temperatures. In some cases, the temperatures are associated with a time period for which device 100 has been exposed to that particular temperature. The x-axis represents the length of the movement or the stroke length of the cores in device 100 in inches. The y-axis represents the error, which in this instance is the difference between the expected voltage output and the actual voltage output based on a particular input (i.e., stroke length or current input to coils). As shown in FIG. 7, the error at temperatures ranging from 500° F. to 580° F. is within a range of 0.004 expected volts out/actual volts out.

Referring to FIG. 8, shown is a schematic diagram of an electromagnetic wound coil suitable for performing exemplary embodiments of the present disclosure. In this embodiment, device 800 having a casing 802 surrounded by polyether-ether-ketone coated coiled conductor 804 that is disposed in potting compound 806. Coiled conductor 804 is operably coupled to AC source 808. AC source 808 is operable to apply a current through coiled conductor 804. Casing 802 defines a hollow cavity 810 which extends through the long axis of casing 802. Hollow cavity 810 slideably maintains core 812. Core 812 is operably coupled to sensor 814, which is operable to measure a movement of core 812 through the long axis of casing 802. Core 812 is operable to slideably move through hollow cavity 810 in response to a magnetic field created when a current is applied to coiled conductor 804. Thus, sensor 814 is operably to measure for magnetic field changes. Embodiments provide that sensor 814 is operable to sense changes in magnetic flux due to current passing through coiled conductor 804.

Referring to FIG. 9, shown is an alternative embodiment of a device suitable for performing exemplary embodiments of the present disclosure. Shown in FIG. 9 is device 900 having cores 902, 904 surrounded by coiled conductors 906, 907, 908, and 909. Coiled conductors 906, 907, 908, and 909 are not coated with polyether-ether-ketone coating and are disposed in potting compound 920. In the embodiment without polyether-ether-ketone coating, coiled conductors 906, 907, 908, and 909 are encompassed by an insulating polyimide. Cores 902, 904 can slideably move through the long axis of device 900 in response to magnetic fields created by a current passing through coiled conductors 906, 907, 908, and 909. In addition, coiled conductors 906, 907, 908, and 909 are operable to have a current pass through them due to movement of cores 902, 904.

This disclosure has been described in detail with particular reference to an embodiment, but it will be understood that variations and modifications can be effected within the spirit and scope of the disclosure. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method of manufacturing an electromagnetic wound coil assembly, the method comprising:
(a) providing a coiled conductor; and
(b) applying one of a polyether-ether-ketone and a polyimide insulation coating to encompass at least a portion of an outside surface of the coiled conductor, wherein the polyether-ether-ketone coating and the polyimide coating substantially prevents degradation of the coiled conductor up to at least 525 degrees Fahrenheit.

2. The method according to claim 1, wherein the coiled conductor is comprised of one of nickel, copper, aluminum, and a carbon nanotube.

3. The method according to claim 1, wherein the coiled conductor is a nickel-plated magnet wire, and wherein the nickel-plating is operable to reduce a rate of oxidation of the coiled conductor, and wherein the nickel-plated magnet wire is copper.

4. The method according to claim 3, wherein the nickel-plating substantially prevents an increase in resistivity [of the coiled conductor between temperatures of 0-525 degrees Fahrenheit.

5. The method according to claim 1, wherein the polyether-ether-ketone coating is at least 0.001 inches thick.

6. The method according to claim 1, further comprising operably coupling a sensor to the coiled conductor.

7. The method according to claim 1, the method further comprising disposing at least a portion of the coiled conductor in a ceramic potting compound, the ceramic potting compound operable to maintain a structural integrity up to at least 1000 degrees Fahrenheit, and wherein the ceramic potting compound is operable to electrically and mechanically isolate the coiled conductor.

8. A method of manufacturing an electromagnetic wound coil assembly, the method comprising:
(a) providing a coiled conductor, the coiled conductor having a coefficient of thermal expansion;
(b) disposing at least a portion of the coiled conductor in a ceramic potting compound, the ceramic potting compound operable to maintain a structural integrity up to at least 1000 degrees Fahrenheit; and
(c) curing the ceramic potting compound.

9. The method according to claim 8, the method further comprising applying a polyether-ether-ketone coating to encompass at least a portion of an outside surface of the coiled conductor, wherein the step of applying is performed prior to the step of disposing, and wherein the polyether-ether-ketone coating substantially prevents degradation of the coiled conductor up to at least 525 degrees Fahrenheit.

10. The method according to claim 8, wherein the coiled conductor is one of nickel, copper, aluminum, and carbon nanotube.

11. The method according to claim 8, wherein the coiled conductor is a nickel-plated magnetic wire, wherein the nickel-plating is operable to reduce a rate of oxidation of the coiled conductor, and wherein the nickel-plated magnet wire is copper.

12. The method according to claim 8, wherein the ceramic potting compound has a coefficient of thermal expansion that is less than the coefficient of thermal expansion of the coiled conductor.

13. The method according to claim 8, wherein the coiled conductor is substantially wrapped by a retaining element prior to the step of disposing, and wherein the retaining element is tape.

14. The method according to claim 8, wherein the ceramic potting compound is one of Sauereisen 13-ZR, Ceramacast 900, and Ceramacast 586.

15. An electromagnetic wound coil assembly comprising:
a coiled conductor having a nickel-plated coating on an outside surface of the coiled conductor, the nickel-plated coating at least partially covered by a poly-ethyl-ether-ketone coating, wherein the nickel-plated coating is operable to reduce a rate of oxidation of the coiled conductor, and wherein the poly-ethyl-ether-ketone coating substantially prevents degradation of the nickel-plated coiled conductor up to at least 525 degrees Fahrenheit.

16. The electromagnetic wound coil assembly according to claim 15, the article further comprising a ceramic potting compound encapsulating at least a portion of the polyether-ether-ketone coated coiled conductor, the ceramic potting compound operable to maintain a structural integrity up to at least 1000 degrees Fahrenheit.

17. The electromagnetic wound coil assembly according to claim 15, wherein the ceramic potting compound has a coefficient of thermal expansion that is less than the coefficient of thermal expansion of the coiled conductor.

18. The electromagnetic wound coil assembly according to claim 16, wherein the ceramic potting compound is one of Sauereisen 13-ZR, Ceramacast 900, and Ceramacast 586.

19. The electromagnetic wound coil assembly according to claim 16, wherein the ceramic potting compound has a coefficient of thermal expansion less than 6.5×10̂−6/° F.

20. The electromagnetic wound coil assembly according to claim 16, wherein the ceramic potting compound substantially surrounds the coiled conductor such that the ceramic potting compound is operable to electrically and mechanically isolate the coiled conductor.
